(19) United States
(12) Patent Application Publication
(10) Pub. No.: US 2017/0109813 A1
(43) Pub. Date: Apr. 20, 2017

(54) MAYBE PILE SORTING MECHANISM

(71) Applicant: HALLMARK CARDS, INCORPORATED, Kansas City, MO (US)

(72) Inventors: SHAWN SAMUEL, SANTA MONICA, CA (US); JOSH McGEE, SANTA MONICA, CA (US); ERIC NOVINS, KANSAS CITY, MO (US); DAN KESSLER, KANSAS CITY, MO (US); KAY LEE, KANSAS CITY, MO (US)

(21) Appl. No.: 15/297,424

(22) Filed: Oct. 19, 2016

Related U.S. Application Data
(60) Provisional application No. 62/243,401, filed on Oct. 19, 2015.

(51) Int. Cl. G06Q 30/06; G06F 7/08

(52) U.S. Cl. CPC G06Q 30/0643; G06Q 30/0623; G06F 7/08

(57) ABSTRACT

A system, method, and user interface for generating a temporal session sorting summary are provided. In embodiments, candidates are selected by a user based on a selection of one or more candidate indicators. Each selected candidate indicator is identified as being associated with one or more features, such as a category and/or an intended recipient. In further aspects, a session sorting summary is generated and at least a portion of representative images of candidates associated with the selected candidates are persistently displayed to a user in the session sorting summary. The representative images of candidates associated with the selected candidate indicators are grouped according to the identified features in the session sorting summary. Upon selection of a candidate in the session sorting summary for personalization, the unselected candidates in the same category and/or under the same intended recipient, are removed from the session sorting summary.

### CROSS-REFERENCE TO RELATED APPLICATIONS

This Nonprovisional Application claims priority to U.S. Provisional Patent Application No. 62/243,401, entitled “Maybe Pile Sorting Mechanism,” filed on Oct. 19, 2015, having attorney Docket Number HALC.208438, the entire contents of which is hereby incorporated by reference.

### SUMMARY

Embodiments of the invention are defined by the claims below, not this summary. A high-level overview of various aspects of the invention are provided here for that reason, to provide an overview of the disclosure, and to introduce a selection of concepts that are further described in the detailed description section below. This summary is not intended to identify key features or essential features of the claimed subject matter, nor is it intended to be used as an aid in isolation to determine the scope of the claimed subject matter.

In brief and at a high level, this disclosure describes, among other things, a system, method, and user interface (UI) for generating a session sorting summary during selection of a sentiment-related item, such as a greeting card (e.g., an email card, a printed card, a movie card, an item of video content, and the like). In further aspects, a system, method, and UI are provided for receiving selections of potential sentiment-related item candidates (e.g., card candidates), sorting such selections by card and/or content category (e.g., birthday, thank you, wedding anniversary, just because, graduation, sympathy, get well, and the like) and/or intended recipient and/or audience (e.g., friend, coworker, classmate, parent, grandparent, child, teacher, and the like), and presenting the potential sentiment-related item candidates according to category and/or recipient for final selection and/or personalization.

### DESCRIPTION OF THE DRAWINGS

Illustrative embodiments of the invention are described in detail below with reference to the attached drawing figures, and wherein:

FIG. 1 is an exemplary user interface of an online product selection display, in accordance with aspects of the disclosure;

FIGS. 2A-2D depict an exemplary UI for providing an online product selection session, with product candidates and a session sorting summary, in accordance with aspects of the disclosure;

FIGS. 3A-3B are an exemplary UI for providing an online product selection session, with product candidates sorted according to different categories and displayed in a session sorting summary, in accordance with aspects of the disclosure;

FIGS. 4A-4C depict an exemplary UI for providing an online product selection session, with product candidates sorted according to one or more intended recipients and displayed in a session sorting summary, in accordance with aspects of the disclosure;

FIG. 5A-5B is an exemplary UI for providing an online product selection session, with product candidates sorted according to one or more intended recipients and one or more categories, and displayed in a session sorting summary, in accordance with aspects of the disclosure;

FIG. 6 is an exemplary UI for a card selection session, with automatically generated session sorting summaries for multiple recipients, in accordance with aspects of the disclosure;

FIG. 7 is an exemplary flow diagram for an online product selection session, in accordance with aspects of the disclosure;

FIG. 8 is an exemplary flow diagram for an online product selection session, in accordance with aspects of the disclosure;

FIG. 9 is an exemplary flow diagram for an online product selection session, in accordance with aspects of the disclosure; and

FIG. 10 is an exemplary system for generating an online product selection session, in accordance with aspects of the disclosure.

### DETAILED DESCRIPTION

The subject matter of select embodiments of the invention is described with specificity herein to meet statutory requirements. But the description itself is not intended to necessarily limit the scope of claims. Rather, the claimed subject matter might be embodied in other ways to include different components, steps, or combinations thereof similar to the ones described in this document, in conjunction with other present or future technologies. Terms should not be interpreted as implying any particular order among or between various steps herein disclosed unless and except when the order of individual steps is explicitly described.

In accordance with aspects of the disclosure, different elements of the described technology will be described as or comprise the following meaning:
(1) Candidate indicator/online product indicator/internet greeting card indicator/card indicator/online product candidate indicator/internet greeting card candidate indicator/card candidate indicator/movie greeting indicator/movie greeting indicator/internet movie content: a thumbnail icon, a title, and/or a description associated with a particular candidate may be included as part of the candidate indicators, the thumbnail, title, and/or description may comprise a representative image of the particular online product (e.g., internet greeting card, printable greeting card, movie greeting, internet movie content, and the like).
(2) Candidate/online product/greeting card/printable greeting card/internet greeting card/movie greeting/internet movie content: are used to refer to the actual product that is to be selected, personalized and sent.
(3) Sorting summary/online product sorting summary/session sorting summary/card sorting summary/temporal session sorting summary/temporal online product sorting summary: “Maybe Pile” for a particular candidate selection session (i.e., “visual listing” of potential candidate online products, cards, and the like, selected by a user.)
(4) Sorting feature/category: particular category identified for the online product (e.g., birthday, promotion, graduation, anniversary, thank you, and the like).
(5) Sorting feature/intended recipient: intended recipient of the online product (e.g., husband, wife, mother, niece, nephew, friend, coworker, teacher, boss, and the like).

In some aspects of the disclosure, a system, method, and user interface for generating a temporal session sorting summary or temporal online product sorting summary during selection of an online product are provided. In particular, a system, method, and user interface are provided for receiving selections of potential online product candidate indicators, sorting such selections by category and/or recipient, and generating and persistently presenting a temporal online product sorting summary to the user until the user finalizes their online session by making a final selection of an online product to personalize and send. Prior to the final selection, every time the user provides an indication to view an online product by, for example, clicking on the respective online product indicator, the online product indicator may be automatically added to the temporal online product sorting summary and persistently displayed to the user in the temporal online product sorting summary, where the temporal online product sorting summary is persistently displayed in a compacted form.

In accordance with aspects herein, when the user decides to review the selected online products in the temporal online product sorting summary, the user may indicate this intended action by hovering over the temporal online product sorting summary and/or click on a general area on the temporal online product sorting summary. When the intended action of the user is received, the temporal online product sorting summary is expanded to present each of the selected online product indicators with one or more options for action associated with each candidate within the temporal online product sorting summary. For example, the temporal online product sorting summary may be expanded to present each of the selected online product indicators with options to save the candidate in a “favorites” folder, remove the candidate from the temporal online product sorting summary, or personalize the online product associated with such candidate. Further, each of the online product candidate indicators in the expanded temporal online product sorting summary may be sorted according to a category (e.g., birthday, holiday, thank you, anniversary, funny, and the like) and/or according to a recipient (father, son, mother, daughter, mother-in-law, father-in-law, teacher, coworker, friend, and the like). Furthermore, if the user decides to continue browsing, the expanded temporal online product sorting summary may be returned to its compacted form. As such, without finalizing a selection of one or more candidates within the temporal online product sorting summary, the candidates presented in the expanded summary may persist in the compacted form when a user returns to browsing additional candidates.

In one embodiment of the invention, one or more computer storage media having computer executable instructions embodied thereon that, when executed by one or more computer processors in a computing device, cause the computing device to perform a method for generating a session sorting summary during selection of an online product. In aspect, the method comprises: presenting one or more online product candidate indicators to a user; receiving a selection of at least one of the one or more online product candidate indicators from the presented one or more online product candidate indicators; generating a temporal session sorting summary based on the received selection of the at least one of the one or more online product candidate indicators, wherein the temporal session sorting summary comprises at least a portion of each of the selected at least one of the one or more online product candidate indicators; persistently displaying the temporal session sorting summary to the user in context of the presented one or more online product candidate indicators, said persistently displayed temporal session sorting summary displaying at least a portion of a representative image for each of the selected at least one of the one or more online product candidate indicators; receiving a final online product selection from the user via the temporal session sorting summary, the received final online product selection comprising an indication of one of the selected at least one of the one or more online product indicators; and upon receiving the final online product selection, generating a deliverable online product according to the final online product selection and resetting the temporal session sorting summary

In another aspect, a method for generating a temporary online product candidate sorting summary during selection of an online product, the method comprising: presenting one or more online product candidate indicators to a user; receiving a selection of at least one of the one or more online product candidate indicators from the presented one or more online product candidate indicators; generating a temporal session sorting summary based on the received selection of the at least one of the one or more online product candidate indicators, wherein the temporal session sorting summary comprises at least a portion of each of the selected at least one of the one or more online product candidate indicators; persistently displaying the temporal session sorting summary to the user in context of the presented one or more online product candidate indicators, said persistently displayed temporal session sorting summary displaying at least a portion of a representative image for each of the selected at least one of the one or more online product candidate indicators; receiving a final online product selection from the user via the temporal session sorting summary, the received final online product selection comprising an indication of one of the selected at least one of the one or more online product indicators; and upon receiving the final online product selection, generating a deliverable online product according to the final online product selection and resetting the temporal session sorting summary.

In a further aspect of the invention, a system for generating a session sorting summary for selecting an online product, is provided. The system includes a computing device having one or more processors and storage media for storing computer executable instructions to perform the computerized method. When the computer executable instructions are performed by the one or more processors, a session sorting engine comprising a receiving component configured to receive one or more user inputs associated with one or more online product candidates receives an input from a user. An identifying component configured to identify a sorting feature associated with each of the one or more online product candidates identifies at least one sorting feature for each selected online product candidate indicator, and a generating component configured to assemble at least one session sorting summary for presentation on a user interface (UI) generates and presents the at least one session sorting summary. The system has access to a database of online products that can be accessible through a network coupled to the computing device and the session sorting engine.

In further aspects, a system for generating a temporal online product sorting summary for selecting an online product is provided. The system comprises: a computing device; one or more computer processors; and one or more computer storage media storing computer executable instructions, wherein when the computer executable instructions are executed by the one or more computer processors, cause: displaying of a plurality of online product candidate indicators on a user interface (UI) associated with the computing device; receiving one or more user inputs from a user, the one or more user inputs associated with one or more of the plurality of online product candidate indicators that are displayed, identifying at least one sorting feature associated with each of the selected one or more online product candidate indicators, and generating at least one temporal online product sorting summary for presentation to the user on the UI and in context of the displayed plurality of online product candidate indicators; and persistently presenting the at least one temporal online product sorting summary to the user, in context of the displayed plurality of online product candidate indicators, wherein the displayed at least one temporal online product sorting summary displays at least a portion of a representative image for each online product candidate associated with each selected online product candidate indicator.

With reference now to the figures, a system, method, and user interface for generating an online product session sorting summary are described in accordance with embodiments in accordance with aspects herein. Various embodiments are described with respect to the figures in which like elements are depicted with like reference numerals.

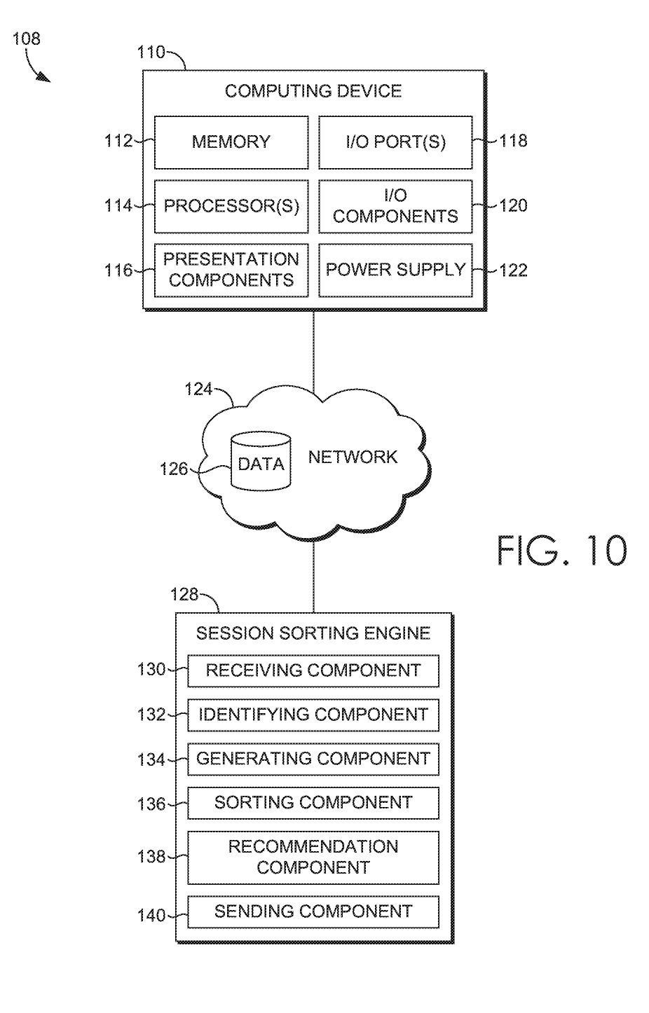

With reference initially to FIG. 10, an exemplary system 108 for implementing embodiments of the present invention is shown. In the example of FIG. 10, a computing device 110 is provided, which is but one example of a suitable computing environment and is not intended to suggest any limitation as to the scope of use or functionality of embodiments of the invention. Neither, should the computing device 110 be interpreted as having any dependency or requirement relating to any one component or any combination of components illustrated.

Embodiments of the invention may be described in the general context of computer code or machine-useable instructions, including computer-useable or computer-executable instructions such as program modules, being executed by a computer or other machine, such as a personal data assistant or other handheld device. Generally, program modules include routines, programs, objects, components, data structures, and the like, and/or refer to code that performs particular tasks or implements particular abstract data types. Embodiments of the invention may be practiced in a variety of system configurations, including handheld devices, consumer internets, general-purpose computers, more specialty computing devices, and the like. Embodiments of the invention may also be practiced in distributed computing environments where tasks are performed by remote-processing devices that are linked through a communications network.

With continued reference to FIG. 10, the computing device 110 includes one or more of the following devices, which may be directly or indirectly coupled, according to embodiments of the invention: a memory 112, one or more processors 114, one or more presentation components 116, one or more input/output (I/O) ports 118, one or more I/O components 120, and an illustrative power supply 122. In embodiments, one or more busses may directly or indirectly couple one or more devices of the computing device 110. Although the various blocks of FIG. 10 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 10 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 10 and reference to “computing device.”

The computing device 110 typically includes a variety of computer-readable media. Computer-readable media may be any available media that is accessible by the computing device 110 and includes both volatile and nonvolatile media, removable and non-removable media. Computer-readable media comprises computer storage media and communication media, computer storage media excluding signals per se. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium that can be used to store the desired information and that can be accessed by computing device 110.

Communication media, on the other hand, embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

The memory 112 includes computer storage media in the form of volatile and/or nonvolatile memory. The memory 112 may be removable, non-removable, or a combination thereof. Exemplary hardware devices include solid-state memory, hard drives, optical-disc drives, and the like. The computing device 110 includes one or more processors 114 that read data from various entities such as the memory 112 or the I/O components 120. The presentation component(s) 116 presents online product indicators (e.g. thumbnails representing online greeting cards, printable greeting cards, video cards, and the like) to a user or other device. Exemplary presentation components include a display device, speaker device, printer device, vibrating component, and the like.

The I/O ports 118 allow the computing device 110 to be logically coupled to other devices including the I/O components 120, some of which may be built in. Illustrative I/O components include a microphone; joystick; game pad; satellite dish; scanner; printer; wireless device; a controller, such as a stylus, a keyboard and a mouse; a natural user interface (NUI); and the like.

Aspects of the subject matter described herein may be described in the general context of computer-executable instructions, such as program modules, being executed by a computing device 110. Generally, program modules include routines, programs, objects, components, data structures, and so forth, which perform particular tasks or implement particular abstract data types. Aspects of the subject matter described herein may also be practiced in distributed computing environments where tasks are performed by remote-processing devices that are linked through a communications network, such as the network 124 of FIG. 10. In a distributed computing environment, program modules may be located in both local and remote computer storage media including memory storage devices. As shown in FIG. 10, the network 124 may include a database 126 configured to provide storage of and/or access to one or more items of data via the network 124. The items of data may comprise, for example, a plurality of online product candidates (e.g., internet greeting cards, printable greeting cards, movie greetings, internet movie content, and the like.)

In some embodiments, exemplary system 108 includes a session sorting engine 128 having one or more of the following components: a receiving component 130, an identifying component 132, sorting component 136, a generating component 134, a recommendation component 138, and a sending component 140. It will be understood by those of ordinary skill in the art that the components and modules illustrated in FIG. 10 are exemplary in nature and in number, and should not be construed as limiting. Any number of components and/or modules may be employed to achieve the functionality described herein. For example, any number of computing devices 110, networks 124, and session sorting engines 128 may be employed by the system 108 within the scope of embodiments hereof. Further, components and/or modules may be located on any number of computing devices 110. Each component and/or module may comprise a single device and/or interface or multiple devices and/or interfaces cooperating in a distributed environment. Further, multiple components and/or modules may include the various components of session sorting engine 128 that collectively perform the tasks of embodiments of the invention. For example, multiple devices arranged in a distributed environment may collectively provide the online product session sorting summary functionality described herein. By way of example, the receiving component 130 may be provided on a single server, a cluster of servers, or a computing device, such as the computing device 110, remote from one or more of the remaining components. In some instances, the receiving component 130, or at least a portion of components included therein, is provided at the computing device 110. Other components and/or modules not shown may also be included within the system 108.

In some embodiments, one or more of the illustrated components and/or modules may be implemented as stand-alone applications. In further embodiments, one or more of the illustrated components and/or modules may be implemented via a computing device (e.g., the computing device 110), as an Internet-based service and/or as a module within the session sorting engine 128. The phrase “application” or “service” as used herein may broadly refer to any software, or portions of software, that run on top of, or access storage locations within, a computing device 110 and/or multiple computing devices 110.

It should be understood that this and other arrangements described herein are set forth only as examples. Other arrangements and elements (e.g., machines, interfaces, functions, orders, and/or groupings of functions) can be used in addition to, or instead of, those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions, including the functions described below with respect to the session sorting engine 128, may be carried out by a processor executing instructions stored in memory.

Turning now to the various components and/or modules of the session sorting engine 128, the receiving component 130 is configured to receive one or more inputs from a user, such as a user input request to personalize, for example, an internet greeting card, preview a particular internet greeting card candidate, add a particular internet greeting card candidate to a session sorting summary (i.e., add the card candidate to a “Maybe Pile” of potential internet greeting card candidates), view a session sorting summary (i.e., view a “Maybe Pile” for a particular greeting card selection session), and/or other user inputs. In response to one or more received inputs, the identifying component 132 is configured to identify a recipient and/or category associated with a session sorting input received in association with each particular internet greeting card candidate. In one example, an identifying component 132 may identify, either automatically or via user input, the intended recipient for a particular internet greeting card candidate, such as a recipient from a list of potential contacts. In another example, an identifying component 132 may identify, either automatically or via user input, the category of a particular internet greeting card candidate being added to a session sorting summary. For example, the receiving component 130 may receive input from the user to preview three potential internet greeting cards. An individual preview for each selected greeting card may be generated each time the user selects each particular greeting card candidate indicator (e.g., a thumbnail showing a representative image corresponding to each individual greeting card candidate). Additionally, upon selection of an internet greeting card candidate indicator, the internet greeting card candidate indicator, a session sorting summary may be generated by the generating component 134 and the internet greeting card candidate indicator may be automatically added to the session sorting summary (alternatively, a user may be asked if he/she would like to add the selected internet greeting card candidate to the session sorting summary in the preview (e.g., by way of a soft button in the preview window)). Each time an internet greeting card candidate is previewed, the identifying component 132 may identify a category for the selected internet greeting card candidate. For example, for a first internet greeting card candidate selection, the identifying component 132 may identify a first category (e.g., graduation), for a second internet greeting card candidate selection, the identifying component 132 may identify a second category (e.g., birthday), or the identifying component 132 may identify the first category (e.g., graduation), and for a third internet greeting card candidate selection, the identifying component 132 may identify a third category (e.g., anniversary), or the identifying component 132 may identify one of the first category (e.g., graduation) or the second category (e.g., birthday). When the identifying component 132 identifies two or more internet greeting card candidates are in the same category, the sorting component 136 may sort them so that they are grouped together in the session sorting summary generated by the generating component 136.

Additional features may be made available to the user when the user comprises a user account to which the user is logged in. For example, when logged in, the user may be prompted to create a user profile indicating different user characteristics such as hobbies, age, gender, marital status, birthday, and the like. The user may also be prompted to create a contacts list with for example, names/nicknames, e-mail address, physical address, phone number, birthday, relationship to user, and the like. With this information, a recommendation engine may prompt the user to, for example, send an internet greeting card to one or more of his/her contacts because, for example, their birthday is coming up. Additionally, the recommendation component 138 may recommend a certain category of internet greeting cards depending on the contact's relationship to the user (e.g., husband, daughter, friend, and the like). The recommendation component 138 may also be configured to learn from the user's behavior (i.e., types of internet greeting cards selected for previewing, internet greeting cards ultimately personalized, internet greeting cards saved in a “favorites” folder for future use, greeting cards removed from the session sorting summary after previewing, and the like). The information learned by the recommendation component 138 may then be used to recommend particular internet greeting cards to the user in subsequent sessions. For example, if there were six internet greeting card candidate indicators in the session sorting summary (e.g., birthday cards) and one was selected for sending, the remaining five non-selected internet greeting cards may be recommended to the user when a subsequent similar category event is coming up for another recipient, or in the next calendar year for the same intended recipient.

In accordance with aspects herein, when logged in, the identifying component 132 may further identify an intended recipient for each internet greeting card candidate selection from the user. As such, in response to recipient and/or category identification by the identifying component 132, generating component 134 may be configured to generate a session sorting summary for presentation to a user. In one example, a session sorting summary provided by generating component 134 may present the internet greeting card candidates grouped according to intended recipient, based at least in part on identification by the identifying component 132. In another example, a session sorting summary provided by generating component 134 may further present the internet greeting card candidate indicators grouped into groups according to their respective category under the intended recipient (i.e., a first group may be formed for each intended recipient, then, the cards within the group may be further grouped according to different categories for the same recipient) by sorting component 136. For example, if a user is browsing for internet greeting cards for his/her son's graduation and birthday, and his/her mother's retirement celebration, as the user selects internet greeting cards to preview, and as the internet greeting card candidate indicators are placed into the session sorting summary, the internet card candidates are further sorted into two groups “son” and “mother.” Within the group “son” the cards are further sorted into two groups “graduation” and “birthday.”

Whether logged in or not, the session sorting summary may be persistently displayed to the user as he/she browses through a plurality of internet greeting card candidate indicators. In other words, the session sorting summary remains visible to the user at a particular location on the display even when the user scrolls up and down a webpage, or moves on to a different webpage (i.e. page 2, 3, 4 . . . ) until the user finalizes the session by making a final selection and personalizing and sending the internet greeting card to an intended recipient by the sending component 140.

If logged in, however, the user may be given the option to continue the search session at a later time without losing the internet greeting card candidate selection indicators in the session sorting summary. For example, if the user is not able to make a final selection in a first session, the user may be able to pick up where he/she left off in a subsequent session because the session sorting summary may be stored under the user's account and may be automatically displayed to the user at the subsequent login session. The session sorting summary may be made available to the user regardless of the platform that the user is logged in from (i.e., personal computer, mobile device, tablet, and the like). This is advantageous because, for example, a user may start a session to select an internet greeting card at home on their personal computer, in the middle of the session, the user may need to go somewhere else and therefore, may be able to continue their search by starting a session from their mobile device on the go. Once a final selection of an internet greeting card is made, and the internet greeting card is personalized and sent by the sending component 140, the generating component may revise the session sorting summary. For example, if there are no other categories or recipients remaining, the sessions sorting summary may be reset, or, if there are other recipients or categories remaining, these may be continue to be persistently displayed and the finalized category may be removed from the session sorting summary.

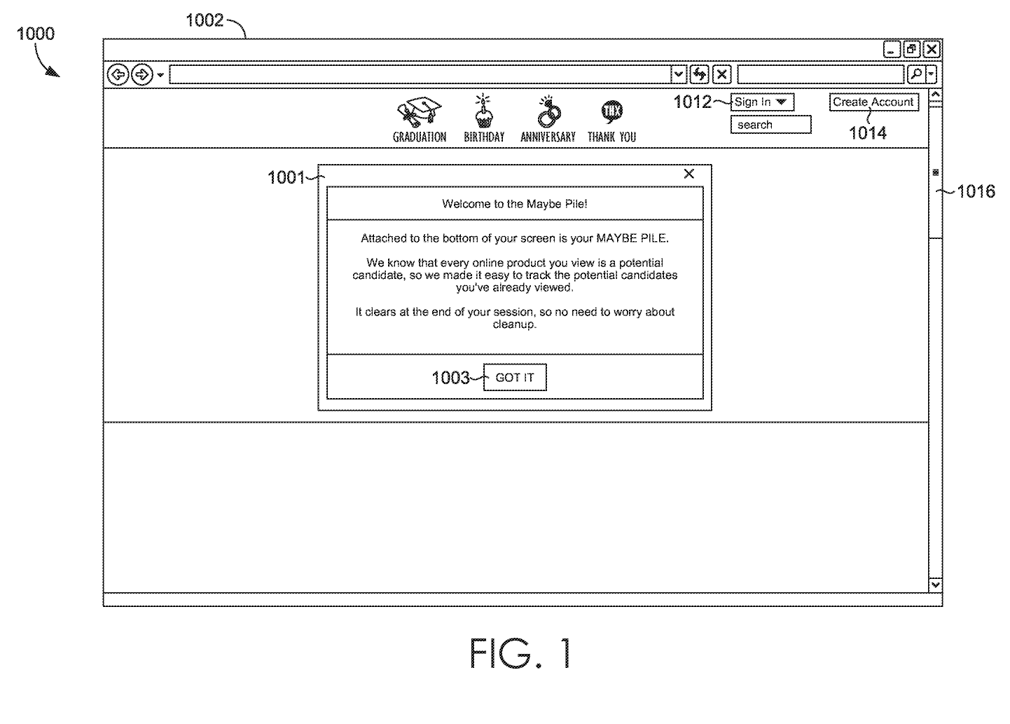

The features described above will become more apparent with reference to FIGS. 1-9. Prior to starting an online viewing/browsing session for selection of an online product, a user may be presented with a message 1001 on an exemplary selection display 1000 used to display a user interface (UI) 1002. The message 1001 may serve to inform the user of the UI 1002 that a session sorting summary 1010 will be generated to aid the user in keeping track of potential online products that may satisfy the needs of the user. The message 1001 may also serve to instruct the user about how the session sorting summary 1010 works and what to expect. When the user is ready, the user may initiate the online viewing/browsing session by clicking, for example, on a message closing indicator 1003 displayed as part of the message 1001. Once the message closing indicator 1003 is selected, the message may be removed from the selection display 1000.

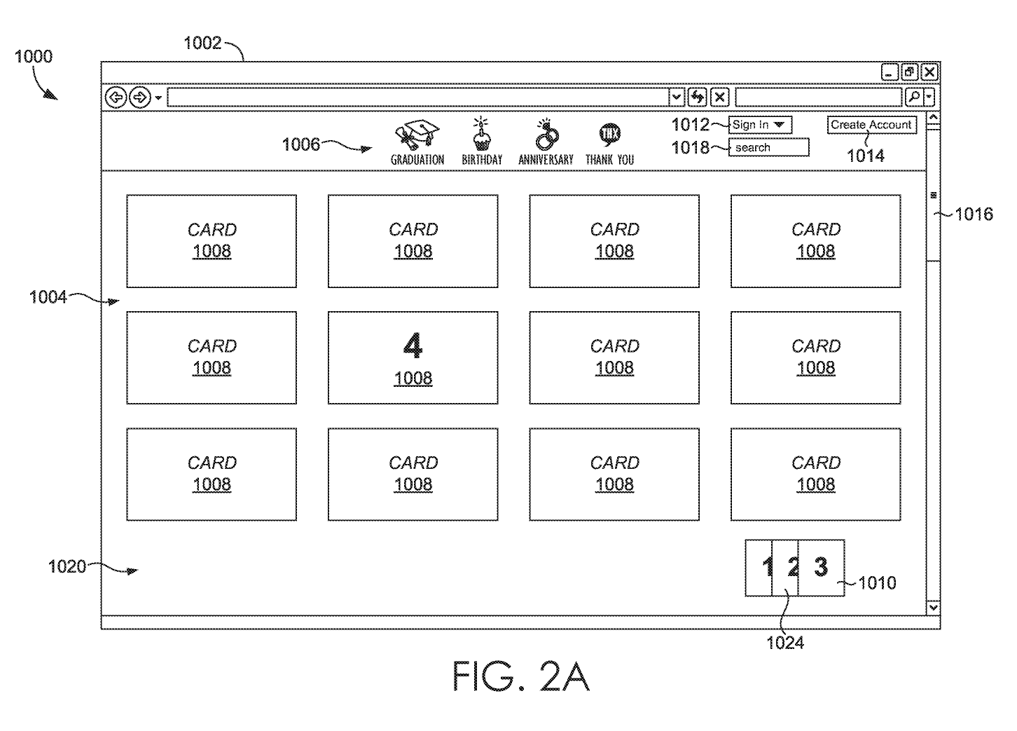

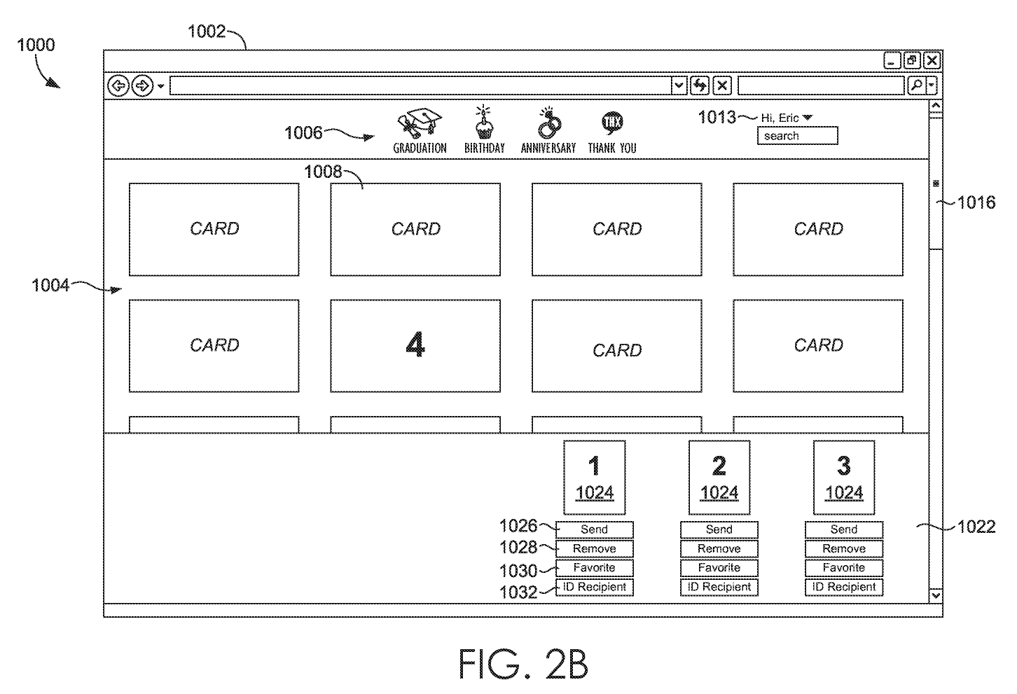

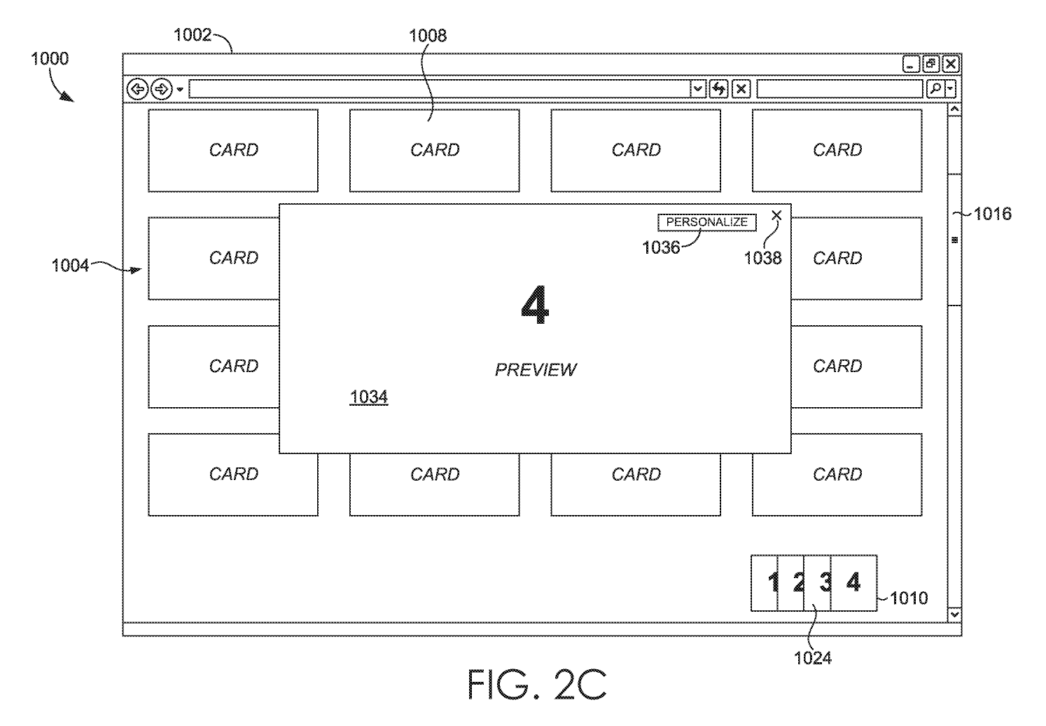

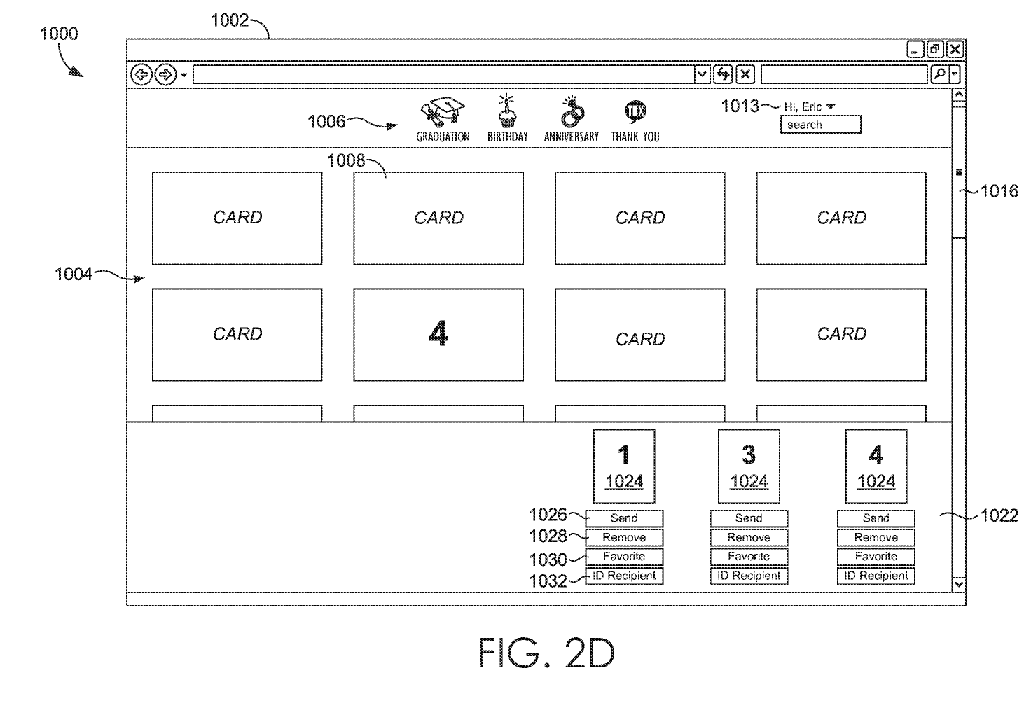

As shown in FIG. 2A, the exemplary selection display 1000 is provided in accordance with aspects of the disclosure. In some aspects, the UI 1002 may include one or more items of UI content 1004, including one or more content category indicators 1006 and one or more candidate indicators 1008. In some aspects, based on user interactions with the UI 1002 of FIG. 2A, a particular candidate indicator 1008 may be selected by the user for viewing the associated candidate. As the user continues his/her browsing session and selects more candidate indicators 1008 to preview the candidates associated with the candidate indicators 1008, the images representative of the selected candidate indicators 1008 may be automatically reproduced and added to a session sorting summary 1010 as candidate images 1024. Alternatively, the user may be given an option whether to display the particular candidate image 1024 in the session sorting summary 1010. For example, when the user is previewing the candidate associated with a particular candidate indicator 1008, a user may be presented with a prompt (not shown) asking the user whether he/she would like to add the selected candidate image 1024 to the session sorting summary 1010.

In accordance with aspects herein, the UI 1002 may further display a login/sign in indicator 1012 and a create new account indicator 1014 that give the user an option to login/sign in if the user was previously registered or, create an account if the user is a new visitor. (However, the technology in accordance with aspects herein may be usable even if the user chooses not to sign in or create a new account). Once the option to login/sign in or the option to create a new account is selected by the user, the appropriate prompts to take next actions that are conventionally known in the art to sign in or create a new online account may be displayed to the user, and the user may proceed accordingly.

As shown in FIG. 1A, the session sorting summary 1010 is generally presented at a general lower area 1020 of the selection display 1000. However, in a different embodiment in accordance with aspects herein, the session sorting summary 1010 may be made movable so that the user may move it to their preferred location on the selection display 1000. A scrolling functionality 1016 may be provided for the UI 1002 that allows the user to browse up and down the UI content 1004 that is being displayed. Furthermore, the UI 1002 may be provided with one or more content category indicators 1006 (e.g., birthday, thank you, anniversary, graduation, holiday, and the like) so that the user may be able to quickly narrow his/her search by, for example, clicking on the content category indicator 1006 of interest. In addition, the UI 1002 may also be provided with a search functionality 1018 where the user may be able to enter one or more keywords that reflect the user's intent so that only relevant candidate indicators 1008 that are results for the search query are displayed to the user as the UI content 1004 in the UI 1002.

Once generated, the session sorting summary 1010 may be persistently displayed to the user at a designated location on the selection display 1000 regardless of the respective page or position on the page being presently shown to the user during a given session, such as, for example, general lower area 1020 on the selection display 1000. In other words, the session sorting summary 1010 may be persistently displayed in context of the presented candidate indicators 1008 when the user is actively browsing through the candidate indicators 1008. While browsing, the session sorting summary 1010 may remain in a compacted form, for example, showing only a portion of each of the candidate images 1024 that have already been selected for previewing. In other words, the candidate images 1024 in the session sorting summary 1010 may be overlapping with each other (e.g., as in a fanned deck of cards) so that each of the candidate images 1024 are only partially visible, but for, for example, the last candidate image 1024 added to the session sorting summary 1010.

After the user has had the opportunity to make a plurality of selections from the candidate indicators 1008, the user may choose to view the selected candidate indicators 1024 in the session sorting summary 1010 by hovering over (e.g., with a mouse pointer via a mouse) and/or by clicking on a first area occupied by the session sorting summary 1010 on the selection display 1000. Once the system (i.e., session sorting engine 128) receives an indication from the user that they want to view the selected candidate images 1024 in the session sorting summary 1010, the session sorting summary 1010 may be expanded to occupy a second area larger than the first area, on the selection display 1000.

As seen in FIG. 2B, the expanded session sorting summary 1022, comprises a complete view of each of the selected candidate images 1024 along with options to move forward with each candidate associated with each of the selected candidate images 1024. For example, each candidate image 1024 in the expanded session sorting summary may be selected for personalization by selecting a personalization indicator 1026 associated with the respective candidate image 1024; each candidate image 1024 may be removed from the expanded session sorting summary 1022 by selecting a removal indicator 1028 associated with the respective candidate image 1024; each candidate image 1024 may be saved into a “favorites folder” (when the user is logged in) for quick retrieval of the associated candidate on subsequent sessions, by selecting a favoring indicator 1030 associated with the respective candidate image 1024; each candidate associated with each candidate image 1024 may be assigned to a particular intended recipient by selecting an IDrecipient indicator 1032 associated with the respective candidate image 1024; and the like. Once the user has finished previewing the candidate images 1024 in the expanded session sorting summary 1022, the user may move the mouse pointer to an area outside of the expanded session sorting summary 1022, or the expanded session sorting summary 1022 may comprise an exit indicator (not shown), which when selected, may return the expanded session sorting summary 1022 back to its original size as session sorting summary 1010 in FIG. 2A.

As shown in FIG. 2C, a user may select a particular candidate indicator 1008 for previewing. Upon an indication of the selection is received (by, for example, receiving component 130), a preview window 1034 may be presented to the user, showing the particular candidate associated with the particular candidate indicator 1008. In the preview window 1034, the user may be given the option to personalize the particular candidate by selecting the personalization indicator 1036, or the user may have the option to close out of the preview window 1034 by selecting the exit indicator 1038. Meanwhile, simultaneously, as the preview window 1034 is presented to the user, an image representing the particular candidate indicator 1008 may be generated and added to the session sorting summary 1010 as one of the candidate images 1024 representing the selected candidates associated with the selected candidate indicators 1008.

As presented above in reference to FIG. 2B, when an indication to view the candidate images 1024 in the session sorting summary 1010 is received from the user, the session sorting summary 1010 is expanded to session sorting summary 1022 presenting a full view of each of the candidate images 1024 along with options for each of the candidate associated with each candidate image 1024. If while viewing the candidate images 1024, the user decides against one of the candidates, the user may delete/remove the particular candidate image 1024 that he/she does not want to keep by selecting its corresponding removal indicator 1028. Then, the expanded session sorting summary 1022 and the compact (i.e. normal size) session sorting summary 1010 will only display the remaining candidate images 1024 that the user does want to keep for continued consideration, as shown in FIG. 2D.

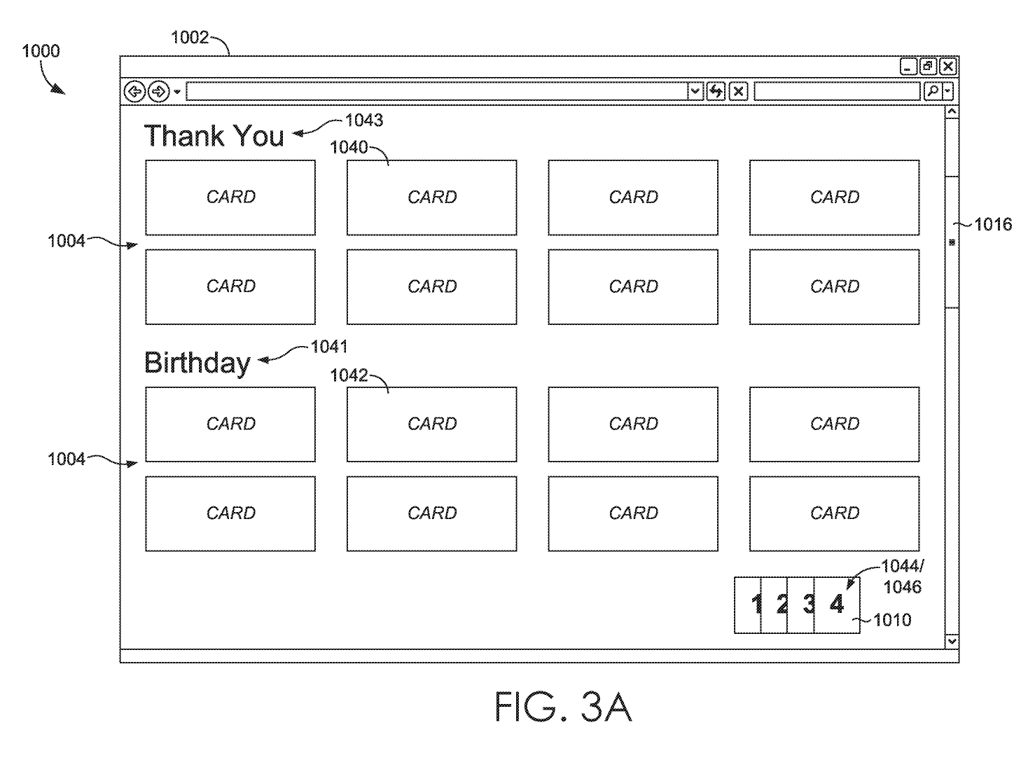

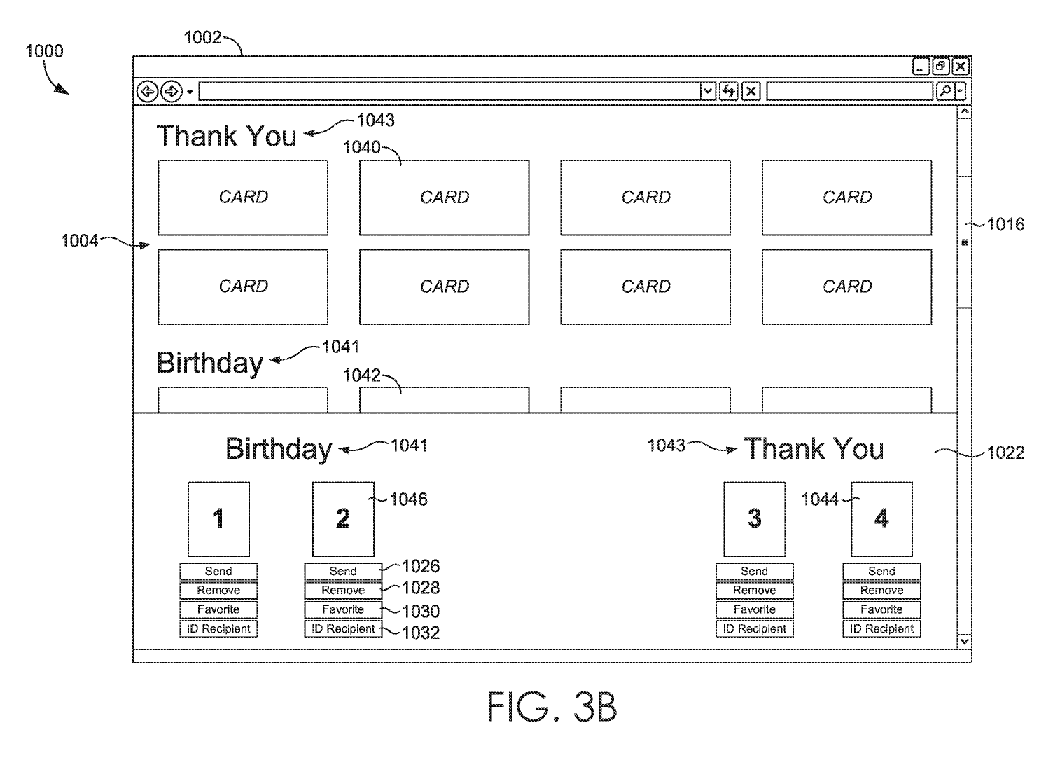

In a different aspect in accordance with the technology described herein, the technology described herein may be used to, for example, present internet greeting cards to a user. The UI content 1004 may be organized according to specific categories when presented to the user in UI 1002 on selection display 1000. For example, in the UI 1002 in FIG. 3A, the user is presented with UI content 1004 associated with internet greeting cards 1040 in a “thank you” category 1043 and “birthday” category 1041. According to FIG. 3A, the user has previewed four internet greeting card candidates in categories 1041 and 1043 since there are four candidate indicators persistently displayed in session sorting summary 1010 on selection display 1000.

When an indication to view the candidate images 1044/1046 in the session sorting summary 1010 is received, the session sorting summary 1010 may be expanded to present the expanded session sorting summary 1022, as shown in FIG. 3B. Unlike FIGS. 2B and 2D, the candidate indicators in FIG. 3B are further organized/grouped according to their respective category. For example, the candidate images 1046 in the expanded session sorting summary 1022 are grouped under the “birthday” category 1041, while the candidate images 1044 in the expanded session sorting summary 1022 are grouped under the “thank you” category. As described above, each of the candidate images 1044/1046 in the expanded session sorting summary 1022 are associated with at least one of their respective personalization indicators 1026, removal indicators 1028, favoring indicators 1030, and/or IDrecipient indicators 1032. Although only indicators 1026, 1028, 1030, and 1032 are shown, one of ordinary skill in the art will recognize that indicators 1026, 1028, 1030, and 1032 are exemplary in nature and are not to be construed as limiting. In other words the number of indicators associated with each candidate image 1044/1046 may be varied according to the particular application in accordance with the present technology.

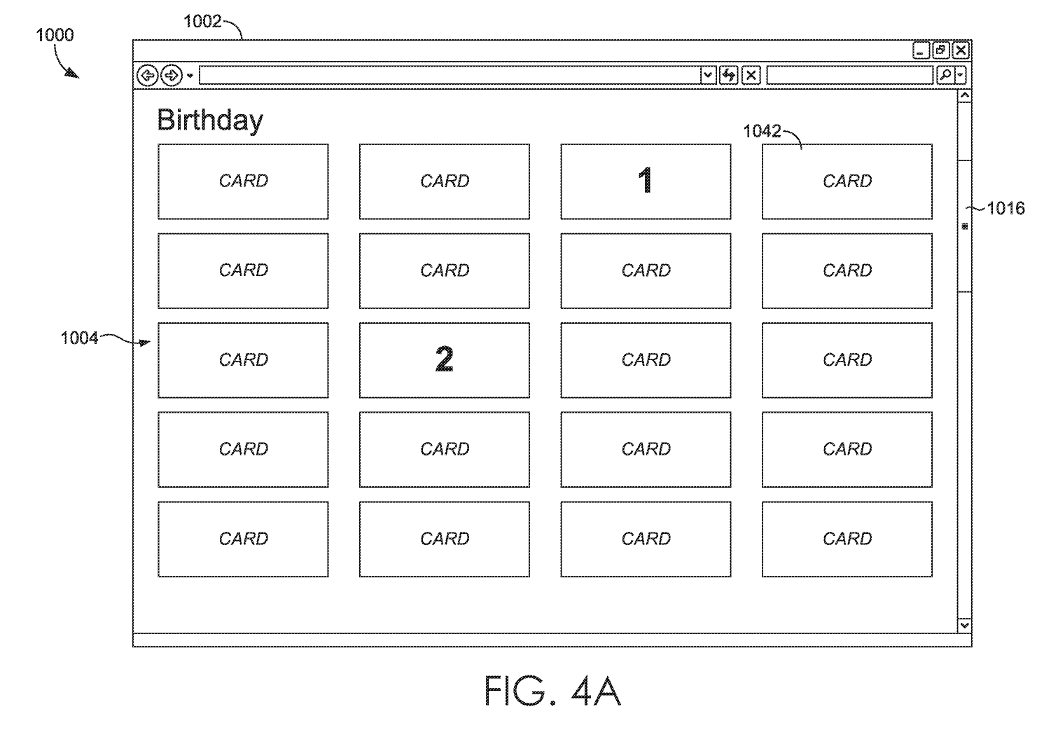

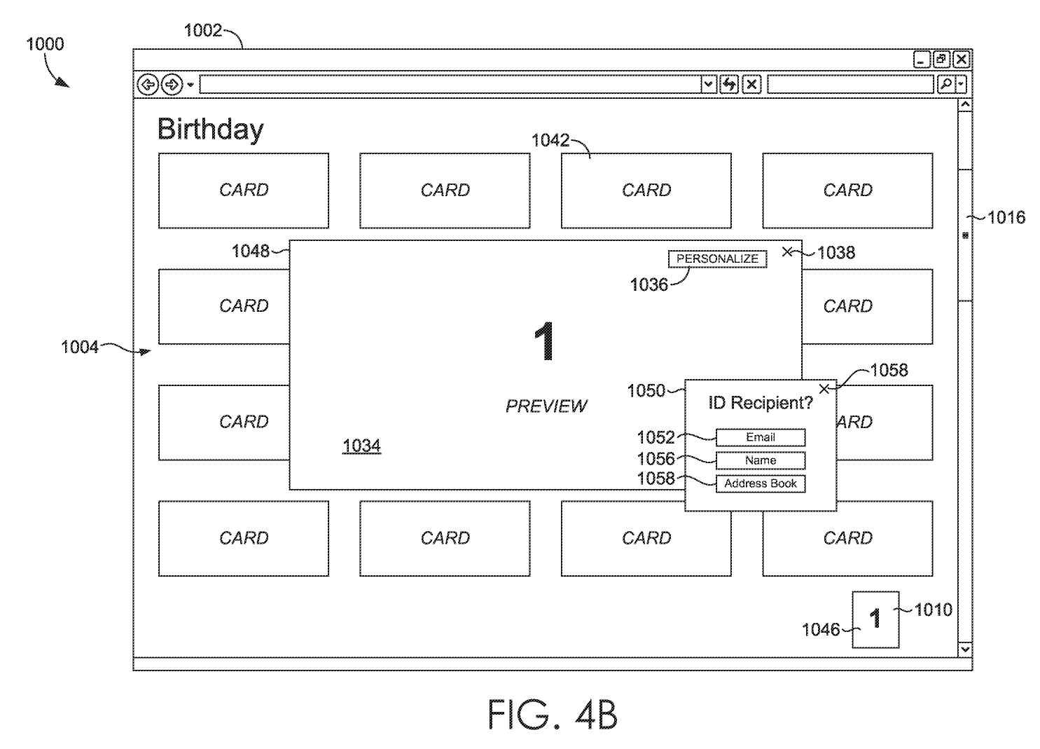

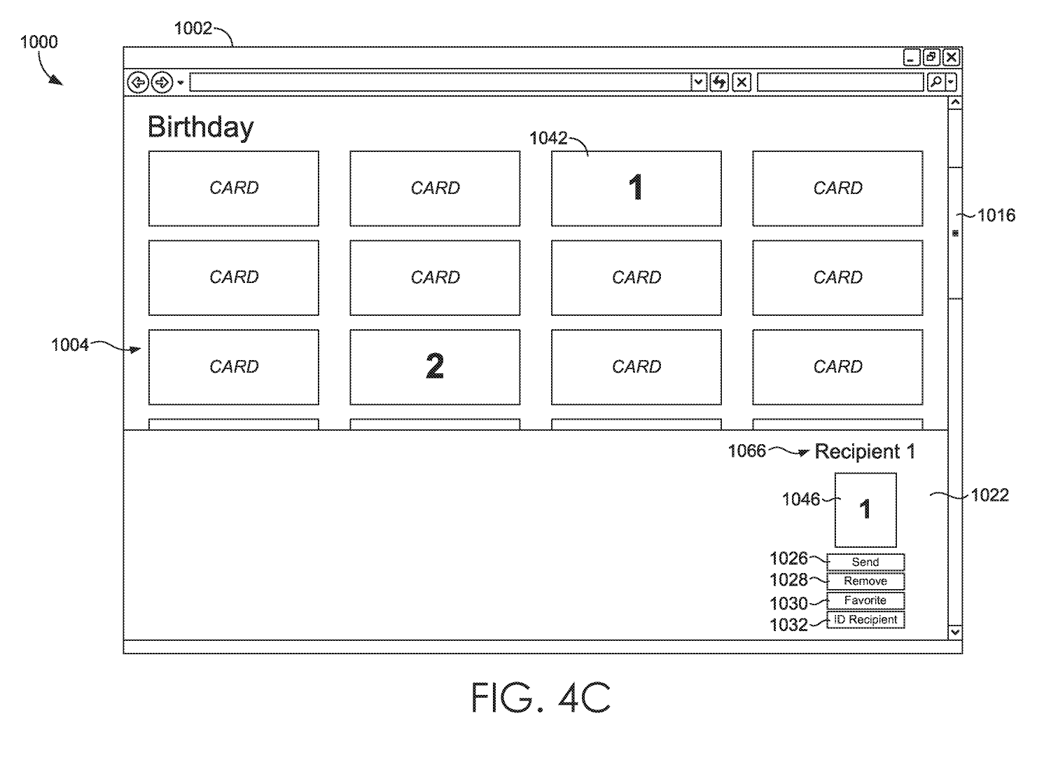

FIGS. 4A-4C illustrate a different aspect in accordance with the present technology. In FIG. 4A, a selection display 1000 displaying UI content 1004 in UI 1002 associated with internet greeting cards in a specific category (“birthday”), is shown. Each of the candidate indicators 1042 displayed is associated with a respective internet greeting card. A user is able to navigate up and down the UI content 1004 via scrolling functionality 1016. In FIG. 4B, the user has selected a first candidate indicator 1042 to preview a first candidate associated with the respective first candidate indicator 1042. The user is presented with a preview window 1034 and an IDrecipient indicator 1050 so that the user can identify (ID) an intended recipient by, for example, entering an email address by selecting email indicator 1052, entering a name by selecting name indicator 1056, identifying from an address book by selecting the address book indicator 1058 (if signed in/logged in), and the like. If the user prefers not to identify an intended recipient, the user may close the IDrecipient indicator 1050 by, for example, selecting the exit indicator 1058, or simply by navigating away from and/or clicking in an area that is outside the area occupied by the IDrecipient indicator 1050. Further, once the user is done previewing the first candidate associated with the first candidate indicator 1042, the user may choose to personalize the first candidate, thereby ending the session, or exit from the preview window 1034, thereby continuing the session. As described above, a session sorting summary 1010 may be automatically generated upon selection of the first candidate indicator 1042, where the session sorting summary 1010 is configured to persistently display at least a portion of a representative first candidate image 1046 corresponding to the first candidate indicator 1042.

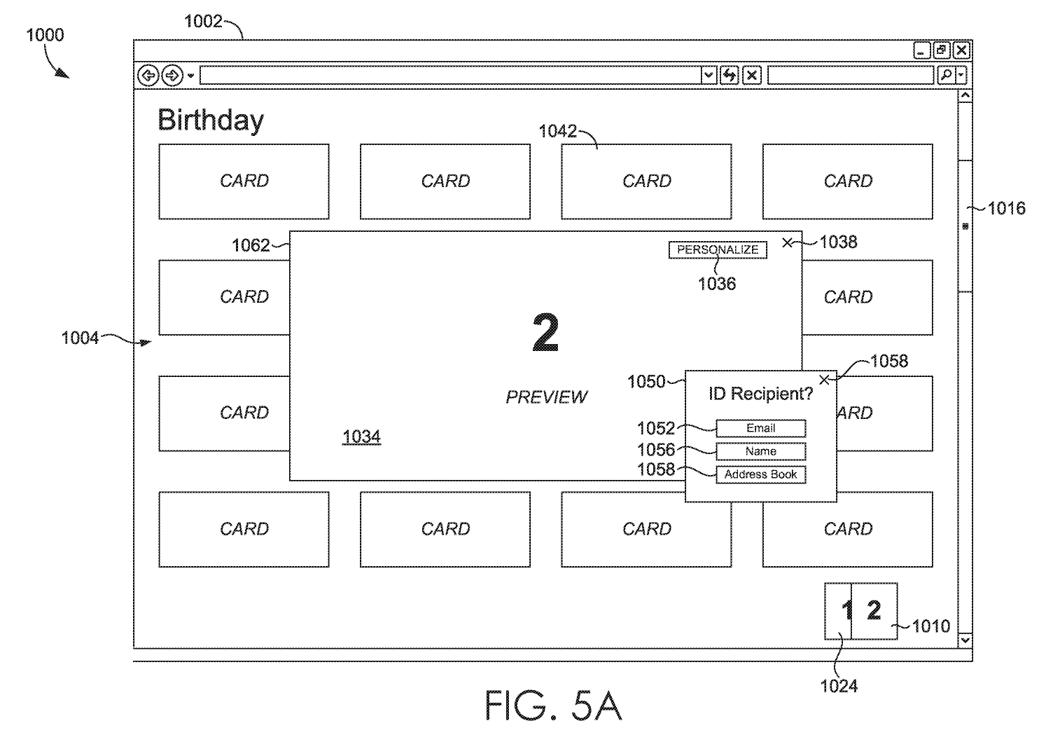

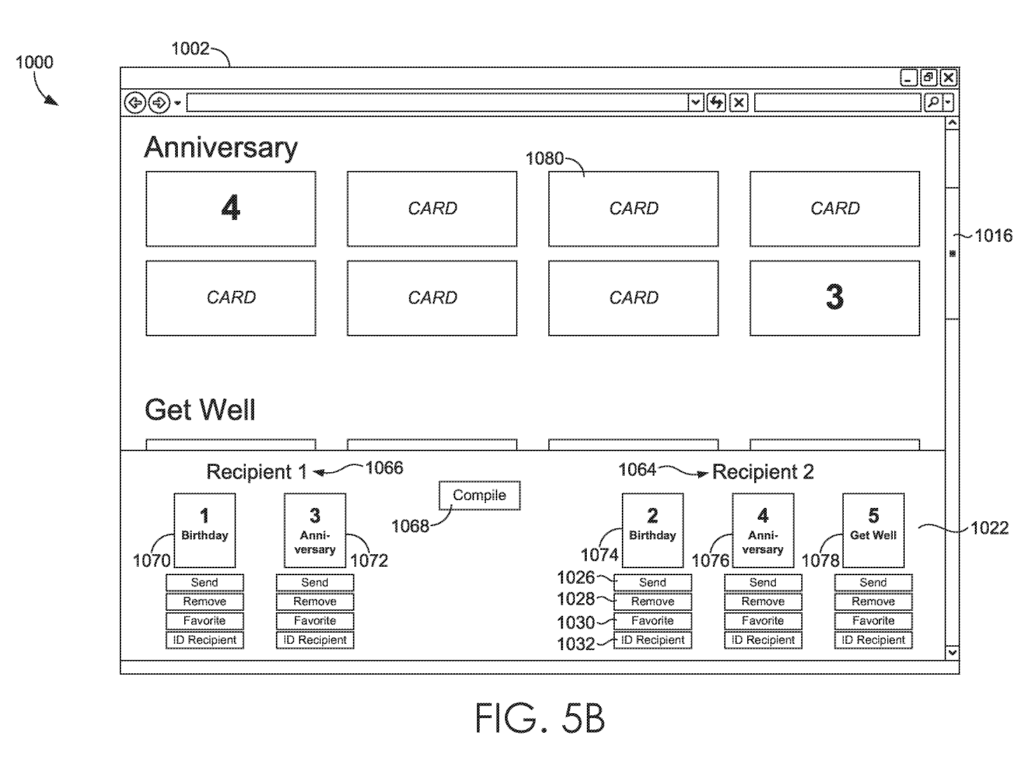

As seen in FIG. 4C, if the user has opted to identify the intended recipient for the first candidate associated with the selected first candidate indicator 1042, the first candidate image 1046 is sorted in the expanded session sorting summary 1022 according to the intended recipient. This will become more apparent with reference to FIGS. 5A-5B.

As shown in FIG. 5A, the user has selected a second candidate indicator 1042 to preview a second candidate associated with the respective second candidate indicator 1042. The user is presented with a preview window 1034 and an IDrecipient indicator 1050 so that the user can identify (ID) an intended recipient by, for example, entering an email address by selecting email indicator 1052, entering a name by selecting name indicator 1056, identifying from an address book by selecting the address book indicator 1058 (if signed in/logged in), and the like. If the user prefers not to identify an intended recipient, the user may close the IDrecipient indicator 1050 by, for example, selecting the exit indicator 1058, or simply by navigating away from and/or clicking in an area that is outside the area occupied by the IDrecipient indicator 1050. Further, once the user is done previewing the second candidate associated with the respective second candidate indicator 1042, the user may choose to personalize the second candidate, thereby ending the session, or exit from the preview window 1034, thereby continuing the session. If the user decides to continue the session, the session sorting summary 1010 may be automatically updated upon selection of the second candidate indicator 1042, where the session sorting summary 1010 is configured to persistently display at least a portion of a representative first and second candidate images 1046 corresponding to the first and second candidate indicators 1042 that have already been previewed by the user. As will be understood, although a preview window is discussed as being part of the candidate selection process described, the preview window may be omitted from the UI 1002 within the scope of various embodiments.

As seen in FIG. 5B, if the user has opted to identify the intended recipient(s) for each previewed candidate associated with their corresponding candidate indicators 1042, the candidate images 1046 may be sorted according to the identified recipient in the in the expanded session sorting summary 1022. Further, in accordance with aspects herein, a user may browse for internet greeting cards in different categories (e.g., birthday, anniversary, get well, and the like) for the same intended recipient in the same session. In such a case, the expanded session sorting summary 1022, may present candidates grouped according to their intended recipient and according to the respective identified category for each candidate.

In the event that there are candidate images 1070, 1072, 1074, 1076, 1078 in multiple categories and/or for multiple intended recipients in the session sorting summary 1010/1022, each category and/or intended recipient may be persistently displayed in the session sorting summary 1010/1020 until a final selection is made for the particular category and/or intended recipient. In other words, if the user chooses to personalize and send a first candidate associated with the first candidate image 1070 in the first recipient category 1066, all the one or more candidate images 1070 associated with the “birthday” category in the first recipient category 1066 may be removed from the session sorting summary 1010/1020, while the candidate images 1072 associated with the “anniversary” category in the first recipient category 1066 would continue to be displayed along with the one or more images 1074, 1076, and 1078 in the second recipient category 1064. If the user selects a final candidate associated with one or more of the candidate images 1072 associated with the “anniversary” category in first recipient category, the unselected one or more candidate images 1072 would also be removed from the session sorting summary 1010/1020, and so on, until the user has made a final selection for each category represented in the session sorting summary 1010/1020 for the session.

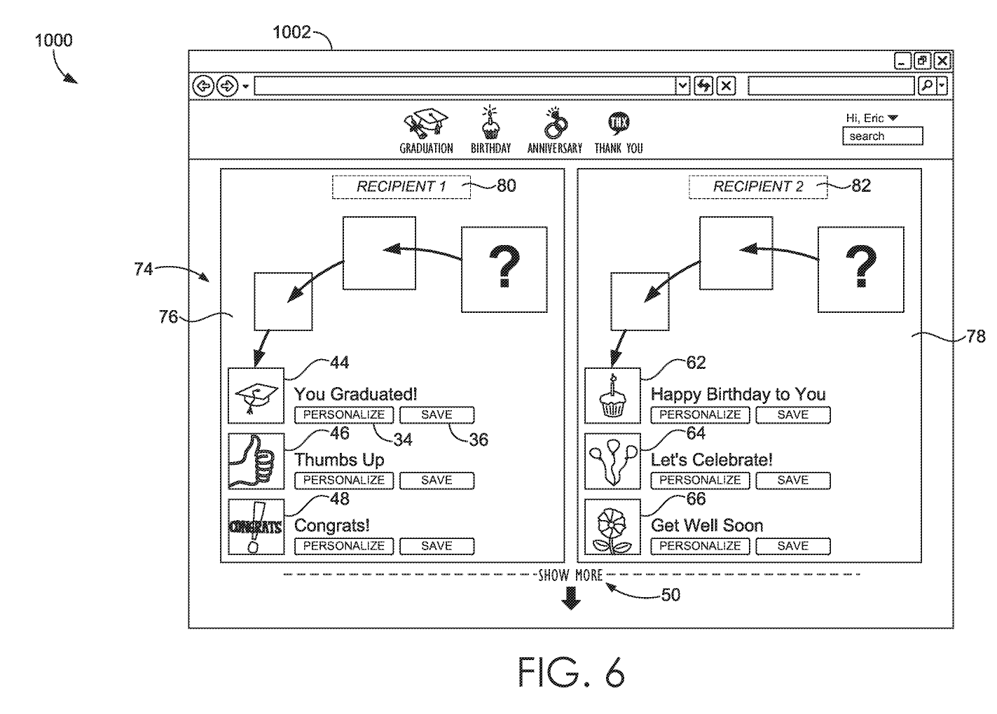

As shown in FIG. 5B, the categorization of the candidates selected by the user may comprise multiple levels such as intended recipient (1066/1064) and category (e.g., birthday, anniversary, get well, and the like). Depending on the number of images associated with candidates and their respective categories, the user may be given the option to view the candidate images 1070, 1072, 1074, 1076, and 1078 in a different format by selecting a compile indicator 1068 in the session sorting summary 1022. As such, with reference to FIG. 6, the selection display 1000 displaying UI content 74 of UI 1002 may now include a first recipient display 76 and a second recipient display 78, which correspond to a first recipient indicator 80 and a second recipient indicator 82, respectively. As such, in response to a user input of selection of a the compile indicator 1068, embodiments of the invention may provide one or more recipient displays with automatically assembled groupings of candidates based on an indication of an intended recipient associated with each candidate. For example, the first recipient display 76 may include one or more candidate images associated with candidate indicators previously selected during as internet greeting card selection session, such as a first candidate image 44, a second candidate image 46, and a third candidate image 48. Additionally, the second recipient display 78 may include a fourth candidate image 62, a fifth candidate image 64, and a sixth candidate image 66. In some aspects, each candidate image included in a recipient display may include a personalization indicator 34 and/or a save indicator 36. As such, a candidate categorized into a particular recipient display may be selected for personalization during the internet greeting card selection session or may be saved for layer personalization as part of a generic listing of saved cards that are available in a subsequent internet greeting card selection session when the user is signed in/logged in into his/her account.

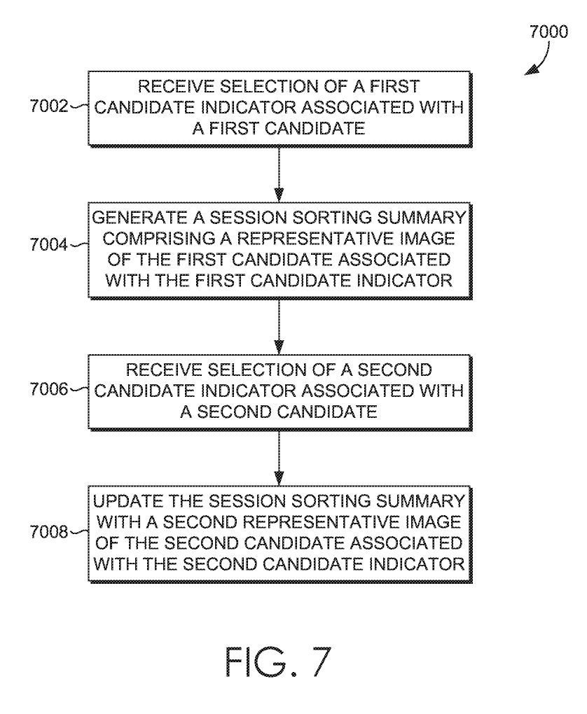

As depicted in the example of FIG. 7, an exemplary flow diagram 7000 for an online product selection session is provided. At block 7002, an indication of selection of a first candidate indicator is received. In response to the received selection, at block 7004, a session sorting summary comprising a representative image of the first candidate associated with the first candidate indicator is generated. At block 7006 an indication of selection of a second candidate indicator is provided. Upon receipt of the indication of selection of a second candidate indicator, the session sorting summary is automatically updated with a second representative image of the second candidate associated with the second candidate indicator at block 7008.

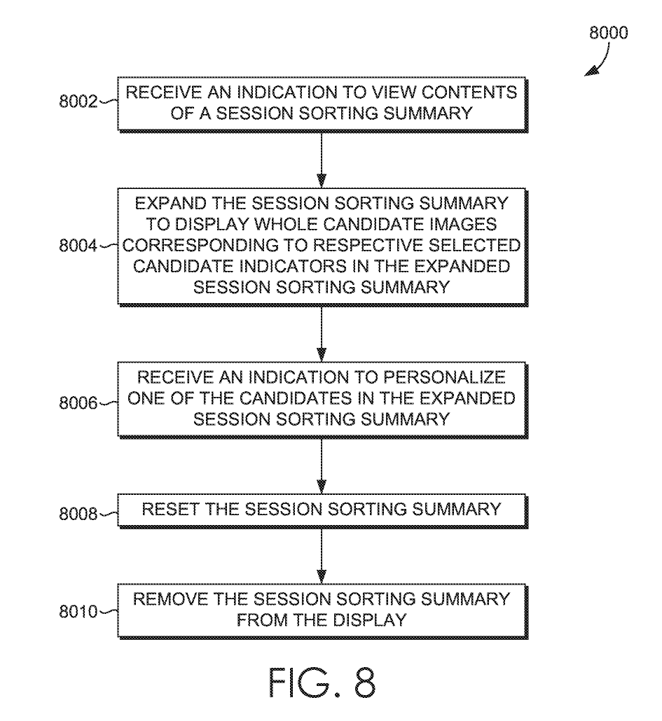

Another exemplary flow diagram 8000 for an online product selection session in accordance with aspects herein, is depicted in FIG. 8. At block 8002, an indication to view contents of a session sorting summary is received. In response to the received selection, at block 8004, the session sorting summary is expanded to display a representative image of each selected candidate associated with their respective candidate indicators. At block 8006, an indication to personalize one of the selected candidates in the expanded session sorting summary is received. As a result, the session is finalized and the session sorting summary is reset at block 8008, and removed from the display at block 8010.

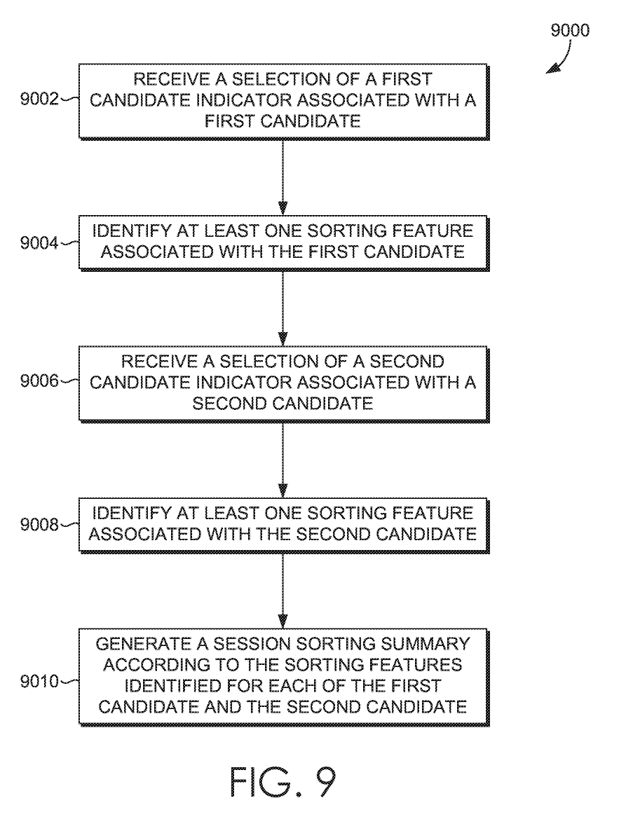

In FIG. 9, yet another exemplary flow diagram 9000 for an online product selection session in accordance with aspects herein, is illustrated. At block 9002, an indication to select a first candidate indicator associated with a first candidate is received. At block 9004, at least one sorting feature associated with the first candidate is identified. At block 9006, a selection of a second candidate indicator associated with a second candidate is received. At block 9008, at least one sorting feature associated with the second candidate is identified, and at block 9010, a session sorting summary according to the sorting features identified for each of the first candidate and the second candidate is generated.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. One or more computer storage media having computer executable instructions embodied thereon that, when executed by one or more computer processors in a computing device, cause the computing device to perform a method for generating a session sorting summary during selection of an online product, the method comprising:
presenting one or more online product candidate indicators to a user;
receiving a selection of at least one of the one or more online product candidate indicators from the presented one or more online product candidate indicators;
generating a temporal session sorting summary based on the received selection of the at least one of the one or more online product candidate indicators, wherein the temporal session sorting summary comprises at least a portion of each of the selected at least one of the one or more online product candidate indicators;
persistently displaying the temporal session sorting summary to the user in context of the presented one or more online product candidate indicators, said persistently displayed temporal session sorting summary displaying at least a portion of a representative image for each of the selected at least one of the one or more online product candidate indicators;
receiving a final online product selection from the user via the temporal session sorting summary, the received final online product selection comprising an indication of one of the selected at least one of the one or more online product indicators; and
upon receiving the final online product selection, generating a deliverable online product according to the final online product selection and resetting the temporal session sorting summary.

2. The computer storage media of claim 1, wherein prior to receiving a final online product selection from the user via the temporal session sorting summary, the method further comprising:
receiving an indication from the user to view the selected at least one of the one or more online product candidate indicators in the temporal session sorting summary; and
expanding the temporal session sorting summary to fully display each of the selected at least one of the one or more online product candidate indicators.

3. The computer storage media of claim 2, wherein the indication to view the selected at least one of the one or more online product candidate indicators in the temporal session sorting summary comprises at least one of hovering over the temporal session sorting summary and clicking within an area covered by the temporal session sorting summary.

4. The computer storage media of claim 1, wherein the receiving a final online product selection from the user further comprises:
receiving an indication from the user to personalize the final online product selection.

5. The computer storage media of claim 1, wherein the deliverable online product comprises at least one of a printed greeting card, an internet greeting card, and an internet movie content.

6. A method for generating a temporary online product candidate sorting summary during selection of an online product, the method comprising:
presenting one or more online product candidate indicators to a user;
receiving a selection of at least one of the one or more online product candidate indicators from the presented one or more online product candidate indicators;
generating a temporal session sorting summary based on the received selection of the at least one of the one or more online product candidate indicators, wherein the temporal session sorting summary comprises at least a portion of each of the selected at least one of the one or more online product candidate indicators;
persistently displaying the temporal session sorting summary to the user in context of the presented one or more online product candidate indicators, said persistently displayed temporal session sorting summary displaying at least a portion of a representative image for each of the selected at least one of the one or more online product candidate indicators;
receiving a final online product selection from the user via the temporal session sorting summary, the received final online product selection comprising an indication of one of the selected at least one of the one or more online product indicators; and
upon receiving the final online product selection, generating a deliverable online product according to the final online product selection and resetting the temporal session sorting summary.

7. The method of claim 6, wherein prior to receiving a final online product selection from the user via the temporal session sorting summary, the method further comprising:
receiving an indication from the user to view the selected at least one of the one or more online product candidate indicators in the temporal session sorting summary; and
expanding the temporal session sorting summary to display a full representative image forof each of the selected at least one of the one or more online product candidate indicators.

8. The method of claim 7, wherein the indication to view the selected at least one of the one or more online product candidate indicators in the temporal session sorting summary comprises at least one of hovering over the temporal session sorting summary and clicking within an area covered by the temporal session sorting summary.

9. The method of claim 8, wherein when the user hovers away or clicks outside of an expanded area covered by the expanded temporal session sorting summary, the method further comprises returning the temporal session sorting summary to its original size.

10. The method of claim 6, wherein the receiving a final online product selection from the user further comprises:
receiving an indication from the user to personalize the final online product selection.

11. The method of claim 6, wherein the deliverable online product comprises at least one of a printed greeting card, an internet greeting card, and an internet movie content.

12. The method of claim 6, wherein the method further comprises identifying at least one sorting feature associated with the selected at least one of the one or more online product candidate indicators in the temporal session sorting summary.

13. The method of claim 12, wherein the at least one sorting feature comprises at least one of a category and an intended recipient.

14. The method of claim 13, wherein the selected at least one of the one or more online product candidate indicators in the temporal session sorting summary are sorted within the persistently displayed temporal session sorting summary according to the at least one sorting feature.

15. A system for generating a temporal online product sorting summary for selecting an online product, the system comprising:
a computing device;
one or more computer processors;
one or more computer storage media storing computer executable instructions, wherein when the computer executable instructions are executed by the one or more computer processors, cause:
(1) displaying of a plurality of online product candidate indicators on a user interface (UI) associated with the computing device;
(2) receiving one or more user inputs from a user, the one or more user inputs associated with one or more of the plurality of online product candidate indicators that are displayed,
(3) identifying at least one sorting feature associated with each of the selected one or more online product candidate indicators, and
(4) generating at least one temporal online product sorting summary for presentation to the user on the UI and in context of the displayed plurality of online product candidate indicators; and
(5) persistently presenting the at least one temporal online product sorting summary to the user, in context of the displayed plurality of online product candidate indicators, wherein the displayed at least one temporal online product sorting summary displays at least a portion of a representative image for each online product candidate associated with each selected online product candidate indicator.

16. The system of claim 15, wherein the at least one sorting feature associated with each of the selected one or more online product candidates indicators comprises at least one of a category indicator and an intended recipient indicator

17. The system of claim 15, wherein the selected one or more online product candidate indicators are displayed in association with the temporal online product sorting summary according to at least one sorting feature in the at least one temporal online product sorting summary.

18. The system of claim 15, wherein receiving the one or more user inputs further comprises receiving an indication from the user to view the selected one or more online product candidates from within the at least one temporal online product sorting summary.

19. The system of claim 18, wherein in response to receiving the indication from the user to view the selected one or more online product candidate indicators from within the at least one temporal online product sorting summary, generating an expanded temporal online product sorting summary.

20. The system of claim 19, wherein displaying the expanded view of the temporal online product sorting summary comprises displaying a full representative image for each online product candidate associated with each respective selected one or more online product candidate. Page 39 of 40
